(19) United States
(12) Patent Application Publication
(10) Pub. No.: US 2007/0001074 A1
(43) Pub. Date: Jan. 4, 2007

(54) Stabilizing apparatus for a portable electronic device

(76) Inventors: Jaeho Choi, Whitestone, NY (US); Ian Jenkins, Stony Brook, NY (US)

Correspondence Address: FAY KAPLUN & MARCIN, LLP, 15O BROADWAY, SUITE 702, NEW YORK, NY, 10038, US

(21) Appl. No.: 11/171,795

(22) Filed: Jun. 30, 2005

(51) Int. Cl. G01J 1/20

(52) U.S. Cl. 248/220.21

(57) ABSTRACT

Described is an arrangement stabilizing a hand-held portable electronic device. The device includes an integral support on which the device rests when placed on a work surface. The arrangement has a stabilizing member including a work surface contacting base and a coupling mechanism securing the stabilizing member to the device in a support configuration. When in the support configuration, a width of the base is greater than that of the integral support. The coupling mechanism is releasable to allow the stabilizing member to move to a stowed configuration. When in the stowed configuration, a profile of the device is reduced in comparison with that in the support configuration.

### BACKGROUND

Over time, mobile computing devices have become more heavily relied on by businesses and are being used in an increasing number of applications. Users of these devices often use them, in certain situations, while held in one or both hands and, in other situations, while resting the device on a table or a desk. When not in use, it is often desirable to store such a device in a holster or other holder on the user's body. These devices have increasingly been designed ergonomically to increase their ease, comfort and efficiency of use. However, the irregular shapes dictated by ergonomic concerns often cause these devices to rest unstably on flat surfaces.

### SUMMARY OF THE INVENTION

The present invention is directed to an arrangement stabilizing a hand-held portable electronic device, wherein the device includes an integral support on which the device rests when placed on a work surface, the arrangement comprising a stabilizing member including a work surface contacting base and a coupling mechanism securing the stabilizing member to the device in a support configuration wherein, when in the support configuration, a width of the base is greater than that of the integral support, the coupling mechanism being releasable to allow the stabilizing member to move to a stowed configuration wherein, when in the stowed configuration, a profile of the device is reduced in comparison with that in the support configuration.

### BRIEF DESCRIPTION OF THE DRAWINGS

FIG. 1 shows a front view of a mobile device for use in conjunction with a stabilizing arrangement according to the present invention;

FIG. 2 shows a rear view of the mobile device of FIG. 1 with no stabilizing arrangement according to the present invention attached thereto;

FIG. 3 shows a side view of the mobile device of FIG. 1 with no stabilizing arrangement attached thereto;

FIG. 4 shows a top view of the mobile device of FIG. 1 with no stabilizing arrangement attached thereto;

FIG. 5 shows a side view of a stabilizing member of a stabilizing arrangement according to the invention;

FIG. 6 shows a side view the mobile device of FIG. 1 with the stabilizing member of FIG. 5 attached thereto;

FIG. 7 shows a top view of the mobile device of FIG. 1 with the stabilizing member of FIG. 5 attached thereto;

FIG. 8 shows a rear view of the mobile device of FIG. 1 with the stabilizing member of FIG. 5 attached thereto;

FIG. 9 shows a perspective view of a mobile device with a stabilizing arrangement according to a further embodiment of the invention in a stowed configuration;

FIG. 10 shows a perspective view of the mobile device of FIG. 9 with the stabilizing arrangement in a deployed configuration;

FIG. 11 shows a perspective view of a mobile device with a stabilizing arrangement according to a still further embodiment of the invention in a stowed configuration; and

FIG. 12 shows a perspective view of the mobile device of FIG. 11 with the stabilizing arrangement in a deployed configuration.

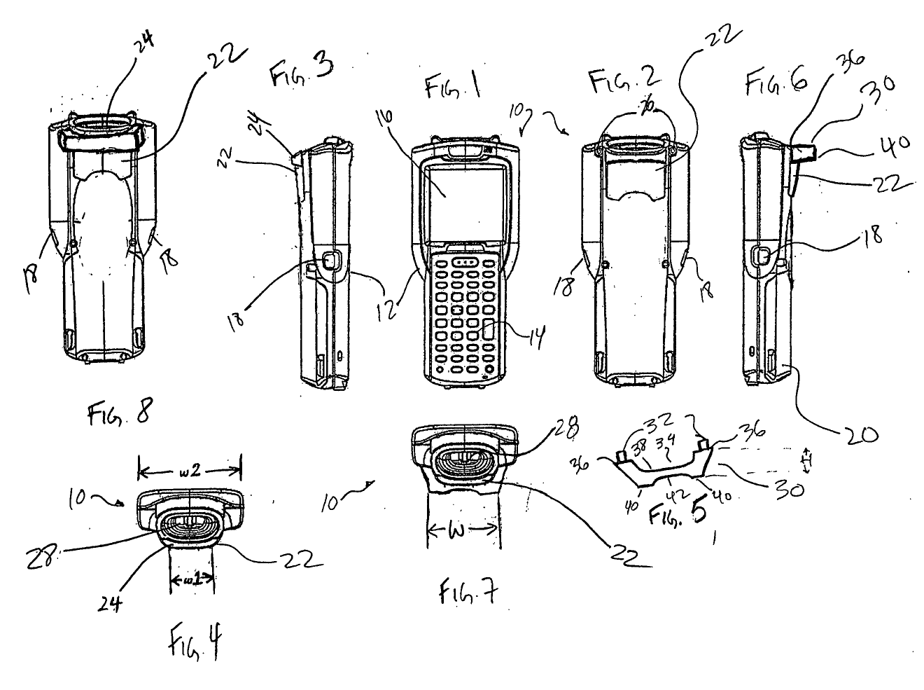

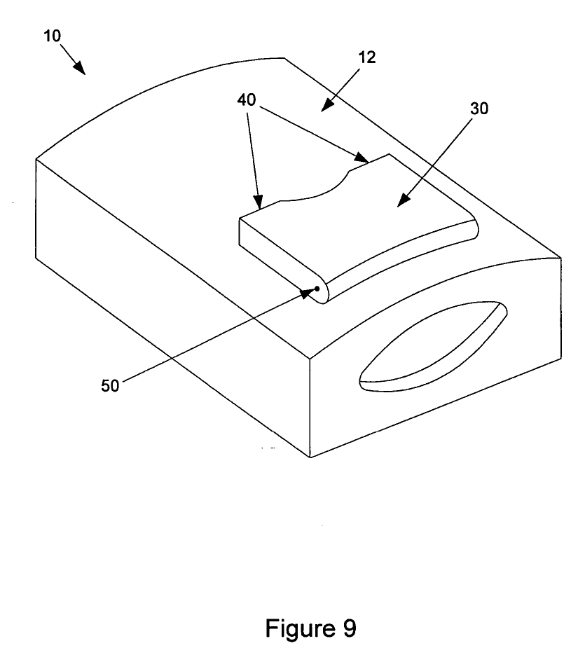

### DETAILED DESCRIPTION

The present invention may be further understood with reference to the following description and the appended drawings, wherein like elements are referred to with the same reference numerals. The present invention will be described in regard to a stabilizing arrangement for a scanning device. However, those skilled in the art will understand that the securing arrangement according to the present invention is equally suited for any irregularly shaped mobile electronic device such as, for example, a personal digital assistant, a cellular telephone, blackberry, etc., which may be manipulated while hand-held and while resting on a flat surface.

As shown in FIGS. 1-4, a scanner 10 includes a housing 12 with a keyboard 14 and a display 16 on a top thereof and a scanning actuator button 18 on a side thereof. A bottom of the scanner 10, including a battery receiving chamber (not shown) closed by a cover 20 and a forward portion including an irregular projection 22 which encloses a scanning engine (not shown) and a light receiving apparatus (not shown). However, those skilled in the art will understand that the bottom of the scanner 10 may include any number of surface irregularities required to accommodate the components of the scanner 10 (e.g., a handstrap) or which are designed to address ergonomic considerations, for example, to enhance a user's grip on the scanner 10 when held in any of a variety of positions, etc. The projection 22 includes an integral stabilizing surface 24 extending thereacross with stabilizer mounting holes 26 formed on either side of the projection 22, preferably adjacent to ends of the integral stabilizing surface 24.

To minimize the volume of the scanner 10 and to facilitate insertion into and removal of the scanner 10 from a holster or other holder, the size of the projection 22 is often minimized so that a width of the projection 22 and the stabilizing surface 24 are only minimally greater than that required for the scanning engine, the light receiving apparatus and an optical path to and from a window 28. For this reason, a width w1 of the integral stabilizing surface 24 is often considerably less than a width w2 of the housing 12. Thus, when the scanner 10 is placed on a table or desk, use of the keyboard 14 often involves the application of force to portions of the scanner 10 outside the width w1 of the integral stabilizing surface. As would be understood by those skilled in art, this may cause the scanner 10 to roll or flip hindering data entry.

To address this tendency, the present invention is directed to a stabilizing arrangement including a stabilizing member 30 which can be selectively mounted on the stabilizer mounting holes 26 of the scanner 10 to increase the lateral stability of the scanner 10 when placed on a surface such as a table for “desk-top” operation. Those skilled in the art will understand that existing features of the housing 12 may be utilized as the stabilizer mounting holes 26. For example, the housings 12 of many such devices include holes which accommodate screws to couple front and back portions of the housing 12 to one another. These holes may be shaped and positioned to receive one or more mounting portions of a stabilizing member 30 thereby simplifying construction of the housing 12.

The stabilizing member 30 may be removed or moved to a stowed position to re-configure the scanner 10 for hand-held operation or for stowing in a holster or other holder, but the location of the stabilizer is carefully selected so as not to compromise or interfere with the ergonomics of the scanner 10. Those skilled in the art will understand that the stabilizing member 30 may be tethered to a hand strap (not shown) or other component of the scanner 10 to facilitate locating and attaching the stabilizing member 30 to the housing 12. According to this embodiment of the invention, the stabilizing member 30 includes a pair of mounting projections 32 which are sized and positioned to be frictionally received within the stabilizer mounting holes 26 of the scanner 10. When the mounting projections 32 are fully inserted into the stabilizer mounting holes 26, abutting surfaces 36 of the stabilizing member 30 contact a surface of the housing 12 of the scanner 10. Furthermore, the stabilizing member 30 includes a recess 34 which has a shape complimenting a shape of an outer surface of the projection 22 so that, when the mounting projections are fully inserted into the stabilizer mounting holes 26, an inner surface 38 of the stabilizing member 30 contacts the outer surface of the projection 22. The stabilizing member 10 includes two feet 40 separated by an indentation 42. When the mounting projections 32 are fully inserted into the stabilizer mounting holes 26, the feet 40 form a stable base on which the forward end of the scanner 10 may rest upon a table, desk or other surface. The stabilizing member 30 is preferably formed of a thermoplastic elastomer.

Those skilled in the art will understand that, although this embodiment shows the stabilizing member 30 extending substantially over the stabilizing surface 24 of the projection 22, the stabilizing member 30 may be mounted at any point on the forward end of the scanner 10 so long as a height “H” of the stabilizing member 30 (e.g., a height of the stabilizing member from an outer surface of the feet 40 to the abutting surfaces 36) is sufficient that, when the stabilizing member 30 is mounted on the scanner 10, the feet 40 raise the scanner 10 above a table or desk on which it is placed so that the conventional stabilizing surface 24 no longer contacts the table or desk. This height “H” is preferably chosen to achieve an angle of the keyboard 14 and the display 16 relative to the table or desk on which the scanner 10 is placed the same as or similar to that when the scanner 10 rests on the stabilizing surface 24. However, those skilled in the art will understand that the placement and/or the height “H” of the stabilizing member 30 may be altered to achieve any desired angle of the scanner 10 relative to a table or desk on which it is placed.

Furthermore, those skilled in the art will understand that, although the stabilizing member 30 is shown with two feet 40 which, when the stabilizing member 30 is mounted on the scanner 10, extend immediately outside ends of the stabilizing surface 24, the feet 40 may be located at any point beneath the scanner 10 so long as they extend further toward outer edges of the scanner 10 than the stabilizing surface 24 (i.e., a width “W” of the feet 40 is greater than a width “w1” of the stabilizing surface 24) and, when not in use for stabilizing the scanner 10, do not interfere with the ergonomics of the scanner 10. Any of a variety of modified arrangements of one or more feet 40 may be used to achieve the goals of the present invention. For example, a stabilizing member 30 may be made with a single foot 40 extending across an entire length thereof, or with an additional foot 40 extending from a center of the indentation 42. It is necessary only that the outer ends of the stabilizing member 40 support the scanner 10 to maximize the stability of the scanner 10 when it is rested on a table or desk.

In addition, as would be understood by those skilled in the art, the combination of the stabilizer mounting holes 26 and the mounting projections 32 may be replaced by any suitable coupling arrangement that allows the stabilizing member 30 to be quickly and securely secured in a deployed configuration and which may then be easily moved to a stowed configuration.

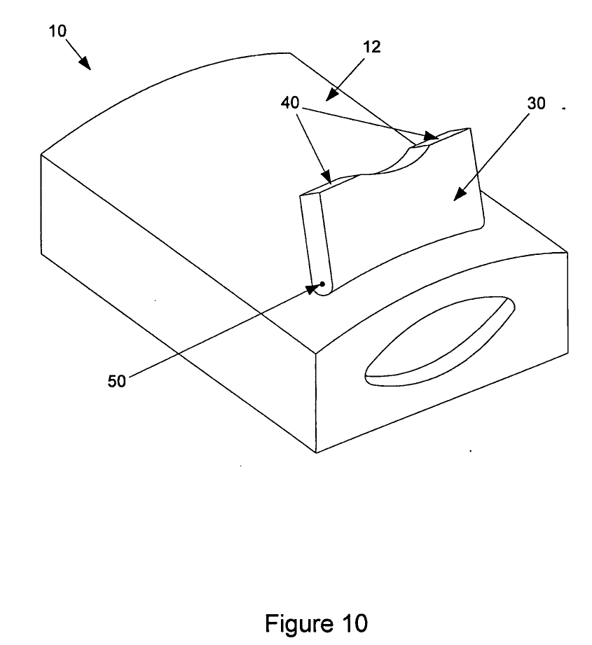

For example, as shown in FIGS. 9 and 10, a stabilizing member 30 according to an alternate embodiment of the invention is coupled to the scanner 10 by hinges 50 for rotation between a stowed position (shown in FIG. 9) in which the stabilizing member 30 is rotated flat against the housing 12 (or received within a recess in the housing 12) to minimize a profile of the scanner 10 and a deployed position (shown in FIG. 10) in which feet 40 of the stabilizing member 30 are extended downward from a rear surface of the housing 12 in a position similar to that of the feet 40 of the arrangement described above, to support the scanner 10 on a table or desk. Similarly, the stabilizing member 30 of this embodiment may be replaced by one or more legs which, when in the stowed configuration, are entirely received within a recess in the housing 12 and which are exposed only when moved to the deployed configuration.

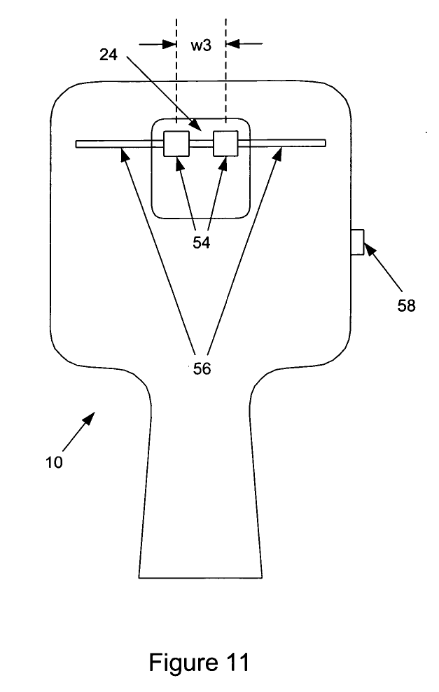

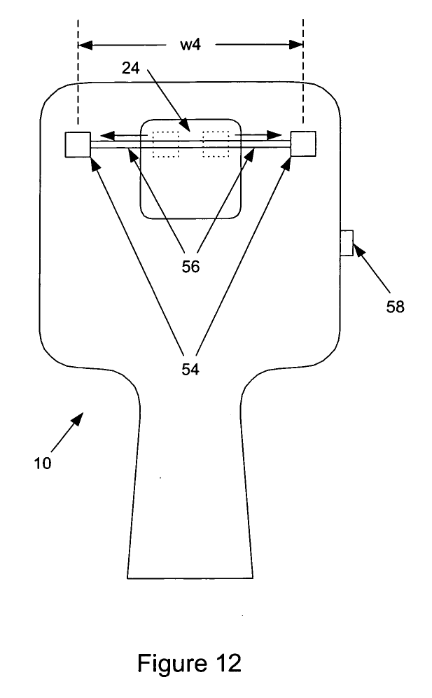

Furthermore, according to still further embodiments of the invention, as shown in FIGS. 11 and 12, a scanner 10 includes a stabilizing arrangement according to a still further embodiment of the invention includes an integral stabilizing surface 24 which, in a stowed configuration (FIG. 11), has a width w3 and which may be moved to a deployed configuration (FIG. 12) in which its width is expanded to w4. Specifically, ends 52 of the integral stabilizing surface 24 include feet 54 which are slidably mounted within slots 56. During hand held use, the width w3 of the integral stabilizing surface 24 is minimized to address ergonomic concerns and to minimize a profile of the scanner 10 (e.g., to facilitate insertion of the scanner 10 into a holster). To configure the device for desktop use, a user pushes an actuator button 58 which operates any of a variety of known mechanisms to move the feet 54 to the deployed configuration. For example, pushing the actuator button 58 may release a latch holding the feet 54 in the stowed configuration against the bias of a spring (not shown) so that the feet 54 slide laterally outward through the slots 56 to the deployed configuration. When finished with desktop operation of the scanner 10, the user may then manually move the feet 54 back to the stowed configuration, engaging the latch to secure the feet in this configuration.

It will be apparent to those skilled in the art that various modifications and variations can be made in the structure and the methodology of the present invention, without departing from the spirit or scope of the invention. For example, those skilled in the art will understand that a stabilizing arrangement according to the present invention may include any number of stabilizing feet which may be attached to any portion of a housing a device to be stabilized so long as, in a stowed configuration, the stabilizing arrangement does not interfere with the ergonomic design of the device. Thus, it is intended that the present invention cover the modifications and variations of this invention provided they come within the scope of the appended claims and their equivalents.

What is claimed is:

1. An arrangement stabilizing a hand-held portable electronic device, the arrangement comprising:
a stabilizing member including a work surface contacting base; and
a coupling mechanism securing the stabilizing member to the device in a support configuration wherein, when in the support configuration, a width of the base is greater than that of an integral support surface on which the device would rest when placed on a flat surface, the coupling mechanism being releasable to allow the stabilizing member to move to a stowed configuration wherein, when in the stowed configuration, a profile of the device is reduced in comparison with that in the support configuration.

2. The arrangement of claim 1, wherein the base includes a plurality of feet, a width of the base extending between outer edges of outer-most ones of the feet.

3. The arrangement of claim 1, wherein a height of the stabilizing member is selected so that, when in the support configuration, the integral support does not contact a work surface on which the device is placed.

4. The arrangement of claim 1, wherein the coupling mechanism includes at least one coupling member receiving opening formed in the device and a coupling member extending from the stabilizing member, the coupling member being sized to be frictionally received within the coupling member receiving opening.

5. The arrangement of claim 1, wherein the coupling mechanism includes a mounting projection extending from the stabilizing member, the mounting projection being sized to be frictionally received within a corresponding mounting hole of the device.

6. The arrangement of claim 1, wherein the coupling mechanism includes a hinge pivotally coupling the stabilizing member to the device for rotation between the stowed and deployed configurations.

7. The arrangement of claim 1, wherein the stabilizing member includes a plurality of feet which, when in the deployed configuration are separated from one another by a distance greater than when in the stowed configuration.

8. The arrangement of claim 5, wherein the stabilizing member is coupled to a hand strap of the device.

9. An apparatus for stabilizing a portable electronic device including a housing with an irrelgularly shaped bottom surface, the apparatus comprising:
a stabilizing member having a height sufficient so that, when placed on a flat surface, the stabilizing member rests on the flat surface and the integral supporting surface is raised out of contact with the flat surface; and
a releaseable coupling for selectively coupling the stabilizing member to and de-coupling the stabilizing member from the housing.

10. The apparatus of claim 9, wherein the releaseable coupling includes a projection extending from the stabilizing member, the projection being sized for a friction fit within an opening in the housing.

11. The apparatus of claim 9, wherein the releaseable coupling includes a hinge rotatably coupling the stabilizing member to the housing for rotation between a stowed position in which the stabilizing member lays substantially flat against the housing and a deployed position in which the stabilizing member projects from a bottom surface of the housing so that, when positioned on a flat surface the stabilizing member contacts the flat surface.

12. The apparatus of claim 11, wherein, when in the stowed position, the stabilizing member rests in a recess shaped so that an outer surface of the stabilizing member forms a substantially continuous surface with portions of the housing surrounding the recess.

13. The apparatus of claim 9, wherein the bottom surface of the housing includes at least one projection extending outward therefrom including an integral supporting surface and wherein the height of the stabilizing member is selected so that, when in the deployed position, the integral supporting surface is raised out of contact with a flat surface on which the housing is positioned.

14. The apparatus of claim 9, wherein the stabilizing member is formed of a thermoplastic elastomer.

15. An apparatus for stabilizing a portable electronic device including a housing with an irrelgularly shaped bottom surface, the apparatus comprising:
a stabilizing member having width in a stowed configuration which is less than a width of the stabilizing member in a deployed configuration; and
a deploying mechanism which, when actuated, moves at least a portion of the stabilizer toward a lateral edge of the bottom surface to increase the of the stabilizing member.
